(19) United States
(12) Patent Application Publication
(10) Pub. No.: US 2006/0057392 A1
(43) Pub. Date: Mar. 16, 2006

(54) Multi-layer sheet having a weatherable surface layer

(76) Inventors: Benjamin Andrew Smillie, Kingston (CA); Geraldine M. Lenges, Wilmington, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/260,307

(22) Filed: Oct. 27, 2005

Related U.S. Application Data
(63) Continuation-in-part of application No. 10/960,426, filed on Oct. 7, 2004.
(60) Provisional application No. 60/509,187, filed on Oct. 7, 2003.

(51) Int. Cl. B32B 27/36; B32B 27/30; B32B 27/06; B32B 27/32

(52) U.S. Cl. 428/421; 428/500; 428/522; 428/523; 428/480

(57) ABSTRACT

A multi-layer sheet and a process for producing the sheet are disclosed. The sheet can comprise a first polymer layer comprising a film of polyvinyl fluoride (PVF) or polyvinylidene fluoride (PVDF) having an adhesive coating on one side; second optionally pigmented polymer layer extruded onto the adhesive coating of the first polymer layer; and optionally a third polymer layer. Also a photovoltaic module comprising a prebonded backskin that comprises the multi-layer sheet.

This application is a continuation in part of application Ser. No. 10/960,426 filed on Oct. 7, 2004, which claims priority of U.S. Provisional Application No. 60/509,187 filed on Oct. 7, 2003.

### BACKGROUND OF THE INVENTION

This invention is directed to a multi-layer sheet and in particular to a multi-layer sheet film that has a surface layer for decorative applications and that can be used as an integrated backing and encapsulant layer for photovoltaic modules.

A variety of processes have been developed to form multi-layer sheet structures that can be molded into parts but each of these processes has problems that make the multi-layer sheet unacceptable, for example, for exterior automotive or truck use or use in photovoltaic modules, due to wrinkles and air-pockets in the multi-layer sheet or insufficient interlayer adhesion. Recycling of scrap multi-layer sheet material also is a problem since the fluoropolymer component of a multi-layer sheet must be separated from the thermoplastic layers of the sheet. When using reflective flakes in the colored layer of the sheet structure, such as aluminum flakes, proper orientation of the flakes must be achieved to have the desired appearance that will not occur unless proper processing conditions and polymers are used.

For example, U.S. Pat. No. 5,707,697 discloses a dry paint transfer process for forming DOI (Distinctness of Image) multi-layer sheet materials. “DOI” is a measure of the “degree of definition” of a reflection of an object in a colored finish compared to the actual object itself. DOI is defined in ASTM Standard-D5767-95 as: distinctness-of-image-gloss, n-aspect of gloss characterized by the sharpness of images of objects produced by reflection at a surface. DOI can be measured with a BYK-Gardner Wavescan DOI instrument. In the automotive industry, satisfactory finishes on a smooth or “Class A” surface typically will have a DOI value of at least 60 and preferably, 80 or higher. U.S. Pat. Nos. 4,931,324; 5,514,427; and 5,342,666 disclose processes for forming injection molded plastic articles having weatherable paint film surface. U.S. Pat. No. 5,114,789 discloses a protective and decorative sheet material having a transparent top coat. U.S. Pat. No. 6,254,712 discloses making high transparency protective and decorative films. U.S. Pat. No. 4,868,030 discloses applying a pre-painted carrier film to an automobile body. U.S. Patent Application Publication 2002/0055006 discloses multi-layer co-extruded ionomer. WO 02066249 discloses co-extruded polymeric coating. WO 9841399 discloses a multi-layered polyester sheet material.

U.S. Pat. Nos. 4,239,555; 4,692,557; and 5,110,369 disclose a variety of solar cell encapsulation methods and encapsulated photovoltaic solar cell modules. Details of the construction of these encapsulated solar cell modules and their associated methods of manufacture are provided in the above-identified patents, which patents are hereby incorporated herein by reference. All of the foregoing patents disclose encapsulating materials that suffer from one or more limitations.

Photovoltaic modules are commonly manufactured in the form of laminated structures. These laminated modules consist of front and back protective sheets, with at least the front sheet being made of clear glass or a suitable plastic material that is transparent to solar radiation, and the back sheet being made of the same or a different material as the front sheet. Disposed between the front and back sheets so as to form a sandwich arrangement are the solar cells and a polymer material that encapsulates the solar cells and is also bonded to the front and back sheets. The laminated sandwich-style module is designed to mechanically support the brittle silicon cells and also to protect the cells against environmental degradation.

The typical mode of forming the laminated module is to assemble a sandwich comprising in order a transparent panel, e.g., a front panel made of glass or a transparent polymer, a front layer of at least one sheet of encapsulant, an array of solar cells interconnected by electrical conductors (with the front sides of the cells facing the transparent panel), a back layer of at least one sheet of encapsulant, and a backskin or back panel, and then bonding those components together under heat and pressure using a vacuum-type laminator. The back layer of encapsulant may be transparent or any other color, and prior art modules have been formed using a backskin consisting of a thermoplastic polymer, glass or some other material.

Although it is known to use a rear panel or backskin that is made of the same material as the front panel, a preferred and common practice is to make it of a different material, preferably a material that weighs substantially less than glass. e.g., a material such as TEDLAR® (the trade name for a polyvinyl fluoride polymer made by E. I. du Pont de Nemours and Company (DuPont)).

There is a need for an extrusion lamination process for forming a multi-layer sheet material wherein a weatherable clear layer is brought together with a relative low melting and optionally pigmented layer and an optional backing layer and the resulting multi-layer sheet under forming or extrusion conditions forms a part with very few imperfections and the multi-layer sheet material is easily recyclable since the weatherable clear layer can be readily separated from the sheet prior to a subsequent forming operation. The multilayer sheet material then simplifies the process of manufacturing photovoltaic modules by then providing a prebonded backskin assembly.

### SUMMARY OF THE INVENTION

This invention comprises photovoltaic module comprising a pre-bonded backskin, said backskin comprising or produced from a multi-layer sheet, said sheet comprising;

a. a first polymer layer comprising a film selected from the group consisting of polyvinyl fluoride (PVF) and polyvinylidene fluoride (PVDF) and having an optional adhesive coating on one side;

b. a second polymer layer laminated in a face to face relationship to one side of the first polymer layer, said second polymer layer comprising a polymer selected from the group consisting of (1) an ionomer resin of a copolymer of ethylene and 8-25% by weight, based on the weight of the copolymer, of a C₃-C₈ α,β ethylenically unsaturated monocarboxylic acid at least 35% of acid moieties neutralized with metal ions and (2) a metallocene catalyzed very low density polyethylene (m-VLDPE) and said second layer optionally containing pigments, dyes, flakes and any mixtures thereof; and

c. optionally, a third polymer layer in direct contact with the second layer and bonded to the second layer over at least a portion of its surface.

A multi-layer sheet comprising, or produced from, a first polymer layer comprising a film of polyvinyl fluoride or polyvinylidene fluoride having an adhesive coating on one side; a second polymer layer extruded onto the adhesive coating of the first polymer layer; and optionally, a third polymer layer.

The invention also comprises a process for producing the multi-layer sheet material. The process can comprise combining, such as extruding, a second polymer layer onto the adhesive coating surface of the first polymer layer to produce a multilayer structure; passing the multi-layer structure into a nip of two rolls under pressure; and optionally combining, such as extruding or laminating, a polymer or backing layer onto the pigmented polymer layer.

In a further embodiment, the invention comprises a photovoltaic module comprising a prebonded backskin. The backskin comprises or is produced from a multilayer sheet comprising (a) a first polymer layer comprising a film from the group of polyvinyl fluoride (PVF) and polyvinylidene fluoride (PVDF) and having an optional adhesive coating on a first side, b) a second polymer layer extruded onto the adhesive coating of the first polymeric layer selected from the group of (1) an ionomer resin of a copolymer of ethylene and 8-25% by weight, based on the weight of the copolymer, of a C₃-C₈ α,β ethylenically unsaturated monocarboxylic acid at least 35% of acid moieties neutralized with metal ions or (2) a metallocene catalyzed very low density polyethylene (m-VLDPE) and said second layer optionally contains pigments, dyes, flakes and any mixtures thereof; and (c) optionally, a third polymer layer in direct contact with the second layer and adhered to the second layer.

In a further embodiment of the invention the second side of the first polymer layer can also have other layers laminated thereto. An example of such a first polymer layer would be a PVF/polyester/PVF laminate where PVF is polyvinyl fluoride.

In a still further embodiment of the invention the photovoltaic module comprises a third polymer layer that in turn comprises a polymer selected from the group consisting of (1) an ionomer resin of a copolymer of ethylene and 8-25% by weight, based on the weight of the copolymer, of a C₃-C₈ α,β ethylenically unsaturated monocarboxylic acid at least 35% of acid moieties neutralized with metal ions and (2) a copolymer of ethylene and an vinyl ester.

### DETAILED DESCRIPTION OF THE INVENTION

References in the singular may also include the plural (for example, “a” and “an” may refer to one, or one or more) unless the context specifically states otherwise. The use of numerical values in the various ranges specified in this application, unless expressly indicated otherwise, are stated as approximations as though the minimum and maximum values within the stated ranges were both preceded by the word “about”. In this manner, slight variations above and below the stated ranges can be used to achieve substantially the same results as values within the ranges. Also, the disclosure of these ranges is intended as a continuous range including every value between the minimum and maximum values.

All patents, patent applications and publications referred to herein are incorporated by reference.

For purposes of this invention the following terms are defined:

“Copolymer” means polymers containing two or more monomers and the term is intended to include both “bipolymers” and “terpolymers” as well as polymers produced from more than three co-monomers.

“Gloss” (20° and 60°) is defined in ASTM Standard D2457-97 as, n-angular selectivity of reflectance, involving surface reflected light, responsible for the degree to which reflected highlights or images of objects may be superimposed on a surface.

“Melt Index” (MI) of a polymer is determined by ASTM D 1238 using condition E (190° C./2.16 kg).

“Class A surface” is a surface that by itself has a DOI and gloss of at least 80 and 90.

By “forming” is meant any process that softens or melts the multi-layer sheet or any component thereof and allows it to be shaped. Forming can include the process of thermoforming, and also the process by which the sheet is laid down onto other components of a module and then bonded to those components under heat and pressure, for example using a vacuum-type laminator.

By “adhesive strength” is meant the force per linear unit of width of laminate that is required to separate two layers of a laminate. Adhesive strength is commonly measured by gripping each layer individually in the jaws of a tensile tester and measuring the maximum force that need to be applied during separation of the layers. “Adhesive strength” is synonymous with “peel strength”.

The present invention is directed towards a multi-layer sheet material comprising a first polymer layer, a second polymer layer and an optional third polymer layer. The invention is also directed towards a photovoltaic module manufactured with the multi-layer sheet as a pre-bonded backskin. In one embodiment of the invention, the second or the optional third polymer layers encapsulate a plurality of solar cells that the photovoltaic module comprises.

The first polymer layer can comprise a film of polyvinyl fluoride (PVF) or polyvinylidene fluoride (PVDF) optionally having an adhesive coating on one side, or optionally being treated with a corona or flame treatment or other such treatment known to one skilled in the art so raise the surface energy of the first polymer layer. The first polymer layer can also have other layers laminated thereto. One embodiment of such a first polymer layer would be a PVF/polyester/PVF laminate where PVF is a polymer of vinyl fluoride. A suitable PVF for use in the invention is Tedlar®, a product of DuPont (Wilmington, Del.).

The second polymer layer can be extruded onto the first side of the first polymer layer comprising (1) an ionomer resin of ethylene having a co-monomer content between 8-25% by weight, based on the weight of the copolymer, of a C₃-C₈ α,β-ethylenically unsaturated mono-carboxylic acid with at least 35% of the acid moieties neutralized with metal ions and/or (2) a metallocene-catalyzed very low density polyethylene (m-VLDPE).

The second polymer layer can be laminated under pressure onto the first polymer layer, for example by passing the two layers through the nip between two heated rolls and applying pressure to form an interlayer bond.

The optional third polymer layer can comprise or be produced from ionomers, copolymers of ethylene and a vinyl ester, polyesters, polypropylene, co-polymers of polypropylene, random polymers of polypropylene, blends polypropylene and other polyolefins and can be in contact with and adhered to the second extruded layer.

The multi-layer sheet material can optionally have a relatively low level of adhesion between the first polymer layer (also referred to herein as “fluorocarbon layer”) and the second polymer layer of an ionomer resin or m-VLDPE before any subsequent forming or laminating of the sheet material, for example during a photovoltaic module manufacturing process. This makes it possible to recycle the multi-layer sheet since the fluorocarbon layer can be readily separated from the second layer and the backing layer. The second layer and the optional backing layer can be recycled for these are thermoplastics if not contaminated with fluorocarbon from the top layer. Once the fluorocarbon layer is separated, it also can be recycled.

The invention is also directed towards a photovoltaic module that comprises the multilayer sheet material.

Upon forming a part or manufacturing a photovoltaic module from the novel sheet material or laminating the sheet material to another material the adhesive coating on the fluorocarbon layer can be activated and adhesion can be significantly increased between the fluorocarbon layer and the second layer due to the heat and pressure of the manufacturing processes.

Bonding of the first polymer layer to the second polymer layer can be accomplished by means of an adhesive coating on the first polymer layer, or by a means for treating the first polymer layer by which the surface energy of the first polymer layer is raised. Examples of a means for treating the first polymer layer are corona or flame treatments or other such treatment known to one skilled in the art and that increase the adhesion between the first and second polymer layers when subjected to given conditions of heat and pressure.

The corona treatment is performed by the customarily employed method, in which the film is passed between two conductor elements serving as electrodes, whereby the voltage, in general alternating voltage, applied to the electrodes is high enough to permit spray or corona discharges. By these spray or corona discharges, and without wishing to be constrained by mechanism, the air above the film surface is ionized and reacts with the molecules on the film surface, so that polar groups are obtained in the substantially nonpolar polymer matrix and, as a consequence thereof, the adhesiveness of the film to polar materials is improved. The amount of corona discharge or flame treatment that the first polymer layer is subjected to is an effective amount as determined by the bond strength needed for the application to which the multi-layer sheet will be directed. For example in one embodiment of the invention a low level of adhesive strength is required in the multi-layer sheet before a forming operation then upon forming the bond is strengthened by the heat and pressure of the forming operation. One of ordinary skill in the art will be able to determine an effective amount without undue experimentation.

The second polymer layer optionally containing pigments, flakes dyes and other additives is an ionomer resin or m-VLDPE. This layer can be extruded onto the fluorocarbon before being passed into the nip of two rollers to provide a relatively low but acceptable level of adhesion between the two layers.

The resulting two (multi)-layer sheet structure can be formed into a shape and subsequently optionally back-cladded with an appropriate polymeric material to form an automotive or truck part or panel or a decorative part or panel or a photovoltaic module.

An optional third or backing layer (a polymeric layer), in direct contact with the second layer and bonded to the second layer over at least a portion of its surface, can be extruded or film laminated onto the above 2 layered sheet structure using conventional techniques and provide the necessary level of transparency to the resulting multi-layered structure so that it can be formed over photovoltaic cells, the optional third layer being an encapsulant for the cells. An example of extrusion lamination would be direct casting of a layer of polymer melt onto the 2 layered sheet structure. An example of film lamination would be provision of a film of material for the third layer which is then placed in a face to face relationship with the 2 layered sheet structure and passed through the nip between rolls and subjected to sufficient heat and pressure to form a bond.

The optional backing layer can be one or more polyester, polypropylene, co-polymers of polypropylene, random co-polymers of polypropylene, blends polypropylene and other polyolefins. The optional backing third polymer layer can also be one or more of ionomers, and copolymers of ethylene and vinyl esters. In this case the multi-layer sheet material is suitable for use as a photovoltaic module, said backing layer can form the back encapsulant for the solar cell that the module contains.

After being formed into a module, the adhesion between the fluorocarbon layer and the color layer can be increased by the heat and pressure of the forming process and provide a sufficient level of adhesion.

The multi-layer sheet of the invention may be used in the manufacture of modules comprising different forms of solar cells known to persons skilled in the art. The modules can be produced from the pre-bonded backskins that comprise, and are in turn produced from, the multi-layer sheets of the invention. As is evident from the foregoing description, silicon solar cells of the type contemplated herein comprise silicon wafers with a p-n junction formed by doping, as disclosed, for example, in U.S. Pat. No. 4,751,191, issued Jun. 14, 1988 to R. C. Gonsiorawski et al, U.S. Pat. No. 5,178,685, issued Jan. 12, 1993 to J. T. Borenstein et al, and U.S. Pat. No. 5,270,248, issued Dec. 14, 1993 to M. D. Rosenblum et al. However, the invention may be used also in modules that comprise other crystalline cells formed independently of one another but interconnected by soldered conductors, as well as cells comprising a semiconductor substrate such as germanium or gallium arsenide onto which one or more layers of another crystalline material are epitaxially grown to form one or more junctions, as disclosed, for example, in U.S. Pat. No. 5,944,913, issued Aug. 31, 1999 to H. Q. Hou et al. and U.S. Pat. No. 6,252,287, issued Jun. 26, 2001 to S. R. Kurtz et al.

The multi-layer sheet material of the invention also may be incorporated in modules that comprise so-called thin film solar cells. Typically such solar cell modules are produced by depositing several thin film layers on a substrate such as glass or alternatively a flexible polymeric substrate, with the layers being patterned so as to form a plurality of individual cells that are electrically interconnected to provide a suitable voltage output. Depending on the sequence in which the multi-layer deposition is carried out, the glass substrate may function as the back surface or as a front window for the module. By way of example, thin film solar cells are disclosed in U.S. Pat. No. 5,512,107, issued Apr. 30, 1996 to R. van der Berg; U.S. Pat. No. 5,948,176, issued Sep. 7, 1999 to K. V. Ramanathan et al.; U.S. Pat. No. 5,994,163, issued Nov. 30, 1999 to M. Bodegard et al.; U.S. Pat. No. 6,040,521, issued Mar. 21, 2000 to K. Kushiya et al; U.S. Pat. No. 6,137,048, issued Oct. 24, 2000 to X. Wu; and U.S. Pat. No. 6,258,620, issued Jul. 10, 2001 to D. L. Morel et al. Examples of thin film solar cell modules are those that comprise cadmium telluride or CIGS thin film cells. The term CIGS is the acronym for the composition Cu(InGa)(SeS)₂.

The first polymer layer of the multi-layer sheet material can be a clear layer of a film of PVF or PVDF. The PVF film can be formed from a solution cast high molecular weight PVF that is available commercially under the trademark Tedlar® from DuPont, Wilmington, Del.

PVDF film can be formed from a high molecular weight PVDF having a weight average Mw of 200,000-600,000, preferably 350,000-450,000. Blends of PVDF and alkyl (meth)acrylates polymers can be used, in particular polymethyl methacrylate. Typically, these blends can comprise 50-70% by weight of PVDF and 30-50% by weight of alkyl (meth)acrylate polymers, preferably, polymethyl methacrylate. Such blends may contain compatibilizers and other additives to stabilize the blend.

To provide an acceptable level of adhesion between the first and second layers of the novel sheet material, the PVF or PVDF film can be provided with a thin layer of an adhesive which can be an acrylic polymer and the adhesive layer can be placed in contact with the second layer. This layer can be clear and may contain one or more UV absorbers and/or UV stabilizers and other additives and mixtures thereof.

The second polymeric layer can be an optionally pigmented layer containing pigments, dyes, flakes, such as aluminum flake, other additives, such as UV stabilizers and UV absorbers and mixtures of any thereof. An ionomer resin or m-VLDPE can be used as the polymeric component of the pigmented layer.

The ionomer resin used can be a copolymer of ethylene and a co-monomer with the co-monomer content being between 8-25% by weight, based on the weight of the copolymer, of a C₃-C₈ α,β ethylenically unsaturated mono-carboxylic acid at least 35% of the acid moieties neutralized with metal ions. The ionomer resin can be prepared by conventional polymerization techniques well known to one skilled in the art and can be neutralized with metal ions, in particular zinc, lithium, sodium, magnesium, calcium and any mixtures thereof. Typically useful ionomers can have an acid mole content above 0.7%, neutralization of the acid functional groups to a level greater than 40% and a MI (Melt Index) of less than 5 and preferably in the range of 0.4-4.0.

The ionomers of the present invention can be derived from direct copolymers of ethylene and a C₃-C₈ α,β ethylenically unsaturated mono-carboxylic acid (ethylene acid copolymer) that is at least 35% neutralized with metal ions. “Direct copolymer” means that the copolymer is made by polymerization of monomers together at the same time, as distinct from a “graft copolymer” where a monomer is attached or polymerized onto an existing polymer chain. Methods of preparing such ionomers are well known and are described in U.S. Pat. No. 3,264,272, which is incorporated by reference herein. Preparation of the direct ethylene-acid copolymers on which the ionomers are based is described in U.S. Pat. No. 4,351,931, which is also incorporated by reference herein. Ethylene-acid copolymers with high levels of acid can be produced by use of “co-solvent technology” as described in U.S. Pat. No. 5,028,674 which is also incorporated herein by reference or by employing higher pressures than those at which copolymers with lower acid can be prepared.

The ethylene-acid copolymers used to make the ionomeric copolymer can be copolymers of ethylene and C₃-C₈ α,β ethylenically unsaturated mono-carboxylic acid, particularly acrylic or methacrylic acid. Preferred ethylene-acid copolymers are ethylene/acrylic acid and ethylene/methacrylic acid.

The neutralizing moiety is preferably metal cations such as monovalent and/or bivalent metal cations. It is preferable to neutralize with metal cations. Preferred metal cations include sodium, zinc, lithium, magnesium and calcium or a combination of such cations. Zinc is most preferred.

The preferred level of neutralization can depend on the ethylene-acid copolymers employed and the properties desired. The percent neutralization of the acid groups can be 35% or greater. The level of acid and the degree of neutralization can be adjusted to achieve the particular properties desired. Higher neutralization yields harder products while more moderate neutralization yields tougher products.

Useful ionomer resins can comprise ethylene and 12-18% by weight, based on the weight of the copolymer, of methacrylic acid or 10-15% by weight, based on the weight of the copolymer, of acrylic acid and 35-75% neutralized with one of the aforementioned metallic ions, preferably zinc.

The metallocene catalyzed very low density polyethylenes (m-VLDPE) are made using conditions well known in the art for continuous polymerization. Typically polymerization temperatures of 0-250° C. and pressures from atmospheric to 1000 atmospheres (110 MPa) are used. Suspension, solution, slurry, gas phase or other polymerization methods can be used. A support for the catalyst can be used but preferably the catalysts are used in a homogeneous (soluble) manner. Suitable process conditions and catalysts that can be used to form the metallocene-catalyzed polyethylenes used in this invention are disclosed in U.S. Pat. No. 5,324,800, U.S. Pat. No. 5,278,272, U.S. Pat. No. 5,272,236, U.S. Pat. No. 5,405,922 and U.S. Pat. No. 5,198,401, which patents are hereby incorporated by reference. A preferred m-VLDPE has a density of 0.86 to 0.91 g/cm³ and a MI of 0.5-4.0 g/10 min measured in accordance with ASTM D1238. For example, m-VLDPE is Affinity® PL 1880, an octene ethylene co-polymer having a density of 0.901 g/cm³ made by Dow Chemical Corporation can be used.

When used, pigments can be generally used in amounts of approximately 1.0 to about 100 parts per hundred parts of polymer. Typical pigments that can be used include both clear pigments, such as inorganic siliceous pigments (silica pigments, for example) and conventional pigments. Conventional pigments that can be used include metallic oxides such as titanium dioxide, and iron oxide; metal hydroxides; metal flakes, such as aluminum flake; chromates, such as lead chromate; sulfides; sulfates; carbonates; carbon black; silica; talc; china clay; phthalocyanine blues and greens, organo reds; organo maroons and other organic pigments and dyes. Preferred are pigments that are stable at high temperatures.

Pigments that provide flake effect colors, such as aluminum flake, coated mica flakes and various other flake pigments can be used since the extrusion process allows the flakes to orient themselves in parallel to the surface of the sheet material. Typically, the flake effect pigments can be used in amount of 0.5-10% by weight based on the weight of the polymer used.

Pigments can be formulated into a millbase by mixing the pigments with a dispersing resin that may be the same as or compatible with the material into which the pigment is to be incorporated. Pigment dispersions can be formed by conventional means, such as sand grinding, ball milling, attritor grinding or two-roll milling. Other additives, while not generally needed or used, such as fiber glass and mineral fillers, anti-slip agents, plasticizers, nucleating agents, and the like, can be incorporated.

Ultraviolet (UV) light stabilizers, UV absorbers, antioxidants and thermal stabilizers, anti-slip agents, plasticizers, nucleating agents, and the like can be incorporated into any of the first, second and optional third polymer layers, and into the adhesive coating. Preferably, these components are present in amounts of about 0.5 to about 3.0 (preferably, about 1.0 to about 2.0) parts per hundred parts by weight of the polymer but may be present in lower or higher levels.

Other Components can include additives normally compounded into plastics or added to coating compositions in the adhesive layer and the second co-extruded polymer layer as required for the end use of the resulting product that is formed. These requirements and the additives needed to meet these requirements are well known to those skilled in the art. Typical of the materials that are needed are, for example, UV absorbers, UV hindered amine light stabilizers, antioxidants and thermal stabilizers, processing aids, and the like.

If the part is to be exposed to ultraviolet (UV) light, it is preferred to include one or more UV stabilizers and/or absorbers in the adhesive layer and optionally, in the pigmented layer. Typical UV stabilizers are hindered amine light stabilizers, such as bis(1,2,2,6,6 pentamethyl-4-piperidinyl sebacate) and di[4(2,2,6,6,tetramethyl piperidinyl)]sebacate, poly[[6-[1,1,3,3-tetramethylbutyl]amino-s-triazine-2,4-diyl][(2,2,6,6-tetramethyl-4-piperidyl)imino] hexamethylene[(2,2,6,6-tetramethyl-4-piperidyl)iminol]], Chimassorb® 2020 1,6-hexanediamine, N,N′-bis(2,2,6,6-tetramethyl 1-4-piperidyl)-, polymer with 2,4,6-trichloro-1,3,5-triazine, reaction products with N-butyl-1-butanamine and N-butyl-2,2,6,6-tetramethyl-4-piperidinamine, Tinuvin® NOR 371, a triazine derivative and any mixtures thereof.

Typically useful UV absorbers include: benzophenones, such as hydroxy dodecyloxy benzophenone, 2,4-dihydroxybenzophenone, hydroxybenzophenones containing sulfonic groups and the like; triazoles, such as 2-phenyl-4-(2′,2′-dihydroxylbenzoyl)-triazoles; substituted benzothiazoles, such as hydroxyphenylthiazoles and the like; triazines, such as 3,5-dialkyl-4-hydroxyphenyl derivatives of triazine, sulfur containing derivatives of dialkyl-4-hydroxy phenyl triazines, hydroxy phenyl-1,3,5-triazine and the like; benzoates, such as dibenzoate of diphenylol propane, tertiary butyl benzoate of diphenylol propane and the like; and others, such as lower alkyl thiomethylene containing phenols, substituted benzenes such as 1,3-bis-(2′-hydroxybenzoyl)benzene, metal derivatives of 3,5-di-t-butyl-4-hydroxy phenyl proprionic acid, asymmetrical oxalic acid, diarylarides, alkylhydroxy-phenyl-thioalkanoic acid ester, and hindered amines of bipiperidyl derivatives.

Preferred UV absorbers and hindered amine light stabilizers, all available from Ciba Specialty Chemicals (Tarrytown, N.Y.), are TINUVIN® 0.234 (2-(2H-benzotriazol-2-yl)-4,6-bis(1-methyl-1-phenylethyl)phenol), TINUVIN® 327 (2-(3′,5′-di-tert-butyl-2′-hydroxyphenyl)-5 chlorobenzotriazole), TINUVIN® 328 (2-(2′hydroxy-3′,5′-di-tert-amylphenyl)benzotriazole), TINUVIN® 329 (2-(2′-hydroxy-5′-tert-octylphenyl)benzotriazole), TINUVIN® 765 (bis(1,2,2,6,6-pentamethyl-4-piperidinyl)sebacate), TINUVIN® 770 (bis(2,2,6,6-tetramethyl-4-piperidinyl) decanedioate), and CHIMASSORB® 944 (N,N-bis(2,2,6,6-tetramethyl-4-piperidinyl)-1,6-hexanediamine polymer with 2,4,6-trichloro-1,3,5-triazine and 2,4,4-trimethyl-1,2-pentanamine.

Preferred thermal stabilizers, all available from Ciba are IRGANOX® 259 (hexamethylene bis(3,5-di-tert-butyl-4-hydroxyhydrocinnamate), IRGANOX® 1010 (3,5-bis(1,1-dimethylethyl)-4-hyroxybenzenepropanoic acid, IRGANOX® 1076 (octadecyl 3,5-di-tert-butyl-4-hydroxyhydrocinnamate), Iragnox® 1098 (N,N-hexamethylene bis(3,5-di-tert-butyl-4-hydroxyhydrocinnamamide), IRGANOX® B215 (33/67 blend of IRGANOX® 1010 with tris(2,4-di-tert-butylphenyl)phosphite), IRGANOX® B225 (50/50 blend of IRGANOX® 1010 with tris(2,4-di-tert-butylphenyl)phosphite), and IRGANOX® B1171 (50/50 blend of IRGANOX® 1098 with tris(2,4-di-tert-butylphenyl)phosphite).

The optional third polymer layer material can be any polymers that can provide the backing stiffness, rigidity, transparency and other properties so that the resulting multi-layer sheet can be formed and/or can adhere to the second polymer layer. Typically useful are polyesters, polypropylene, co-polymers of polypropylene, random polymers and co-polymers of polypropylene, blends polypropylene and other polyolefins, ionomers, polyamides, copolymers of ethylene with unsaturated esters, or blends of the forementioned materials. The optional backing third polymer layer can also be one or more of ionomers, and copolymers of ethylene and vinyl esters. In this case the multi-layer sheet material is suitable for use as a photovoltaic module, said backing layer can form the back encapsulant for the solar cell that the module contains.

This optional third layer can be applied to the sheet material of the first and second polymer layers by extrusion or lamination and the resulting sheet can be formed into the desired shape to form, for example a part or panel. After forming, the sheet can be back cladded with a fourth layer usually of a low cost polymer material. Another option is to thermoform the sheet material of the first and second polymer layers and then back clad the formed sheet by injection molding with a third polymer stiffening or cladding layer.

Any of the materials used in the third layer can be used as a cladding material to provide processability and high level of adhesion. Additional useful cladding materials include other high modulus resins that are compatible and form an excellent adhesive bond between the sheet material and the resin that are conventionally used in the manufacture of parts, panels laminates used, for example, in autos, trucks and recreational vehicles and photovoltaic modules.

In the process for forming the multi-layer sheet material, the fluorocarbon layer (film of PVF or PVDF) can be placed into contact with a supporting film of a biaxially oriented polyester film and a layer of the second polymer layer (ionomer resin or m-VLDPE) can be extruded onto the surface of the fluorocarbon layer and the resulting multi-layer structure is passed into a nip of two heated rolls under pressure and optionally, the third and/or subsequent layers can be extruded onto the pigmented polymeric layer.

The polyester film on the multi-layer sheet material can protect the surface of the sheet material and keeps the surface of the sheet material free from dust and debris that can be present and cause surface defects on forming. Generally, the polyester film can be kept in contact with the multi-layer sheet material and removed just before any forming process.

Parts of the multi-layer sheet material can be formed by removing the polyester supporting film, forming the sheet and then, optionally, back-cladding the formed sheet with a polymeric cladding material described above to form a part. In the forming process, sufficient heat and pressure are applied to bond the top layer to the second pigmented layer.

The laminating of the first polymer layer to the second polymer layer can be a simple processing requiring minor modifications to sheet extrusion equipment by the use of a biaxial oriented polyester film as a support sheet for the thin PVF or PVDF film. The bond between the first polymer layer and the polyester film is low so that the polyester film can readily be removed when needed. Also, the bond between the first polymeric layer of a film of a first polymer fluorocarbon polymer and the pigmented polymeric second layer can be low prior to forming or lamination which allows for the removal of the fluorocarbon containing first polymer film to allow for recycling of the first polymeric layer as well as the separated fluorocarbon containing first polymer film.

The combination of the second polymeric layer and the high melting fluorocarbon-containing first polymer layer during vacuum or pressure forming of the multi-layer sheet material significantly can reduce imperfections in the surface of the piece being molded. The second polymeric layer containing an ionomer resin or a m-VLDPE can have a sufficiently low melting temperature and will melt and relax and reduce surface imperfections during the forming process. Also, the low melting temperature and modulus of the second polymeric layer can improve the mar resistance of the first polymer top layer of the sheet material.

Also, the process allows for maximum flake orientation in the second polymeric layer if it is pigmented. The flakes can be allowed to orient in parallel to the surface of the sheet to provide for a uniform appearance and improved “flop”. For example, color differences observed on sheets containing metallic flake pigments when viewed at a 15° angle down the machine direction (MD) of the sheet in comparison to viewing up the MD of the sheet had an acceptable color variation. Also, color differences in the transverse direction of the sheet in comparison to the MD of the sheet can be also acceptable.

The present invention is further illustrated in the following Examples, which do not limit the scope of the invention. In the Examples, all parts and percentages are on a weight basis unless otherwise indicated.

### EXAMPLE 1

The following first polymer film was used to form the multi-layer sheet material: Tedlar® PVF film CUA10AH836 sold by DuPont and is a nominally 1 mil (0.0254 mm) thick solution cast PVF film one side coated with an acrylic adhesive containing 0.2% by weight of Tinuvin® 328 (described above) and 0.5% by weight Chimassorb® 119 and is approximately 0.008 mm thick. The acrylic adhesive is a commercial product code no. 68080 sold by DuPont. The PVF film is cast onto a 3 mil (0.076 mm) thick biaxially oriented PET film (polyethylene terephthalate film).

The following pigmented polymeric concentrates were used to form the second pigmented polymeric layer of the multi-layer sheet materials.

Ionomer pigment concentrate—Surlyn® SG 771 NC002, sold by DuPont, an ethylene/methacrylic acid ionomer containing 15% methacrylic acid 70% neutralized with zinc, MI 0.7 (190° C.), melt point 80° C. and a density 0.96 g/cm³ was dry blended with 7.5 wt. % of a aluminum flake concentrate of 20 weight percent aluminum flake (Sparkle Silver® SSP132AR manufactured by Siberline) in Nucrel® 960 manufactured by DuPont. The concentrate was dried overnight at 45° C. using a desiccated hopper dryer system supplied by Conair Corp.

m-VLDPE pigment concentrate—Affinity® PL 1880 is an octene ethylene co-polymer having a MI of 1, melt point of 102° C. and a density of 0.901 g/cm³ made by Dow Chemical Corporation was dry blended with 7.5 wt. % of a aluminum flake concentrate of 20 weight percent aluminum flake (Sparkle Silver® SSP132AR manufactured by Siberline) in Nucrel® 960 manufactured by DuPont. The concentrate was dried overnight at 45° C. using a desiccated hopper dryer system supplied by Conair Corp.

The multi-layer sheet material was formed as follows: the pigment concentrate was charged into a nitrogen swept hopper of a single screw extruder fitted with a 3/1 compression ratio single flighted screw with a 5 L/D of a melt mixing section. The flight depth in the feed section was 5.3 mm. The extruder dies was 152 mm wide coat hanger type flat film die with a 0.38 mm die gap. The molten pigment concentrate exiting the die was drawn down to a nominal 0.4 to 0.8 mm thick sheet and cast onto the Tedlar® film supported by the PET film on a casting roll and then into the nip of a pneumatically operated 127 mm diameter chrome nip roll and the casting roll to pin the layer of pigment concentrate to the Tedlar® film. The laminated sheet was wound onto a 76 mm paper core and stored.

To minimize or eliminate any wrinkles in the Tedlar® film, it was necessary to apply a significant amount of tension to the unwind of the roll of Tedlar® film that was supported by the PET film. Tension was not measured but was estimated to be on the order of 17Ncm (10 lbf/in) of web.

Using the above process, the following two sheet multi-layer sheet materials were formed. (1) Tedlar® film/ionomer resin pigmented layer and (2) Tedlar® film m-VLDPE resin pigmented layer.

For both of the multi-layer sheets (1) and (2), before any forming or laminating process, the Tedlar® film was readily removable and the Tedlar® film and the pigmented layer could be recycled.

Both of the multi-layer sheets had an excellent appearance in particular, good gloss and DOI. Flop measured up-field and downfield in the MD of the sheet had only slight but acceptable differences. Both sheets were thermoformable using conventional techniques after removal of the PET film and resulted in a formed structure that could be made into an auto or truck part. Adhesion between the Tedlar® film and the pigmented layer in both sheets increased significantly after forming and was acceptable for auto and truck parts. Appearance of the formed parts was excellent particularly in regard to gloss and DOI. Each of the formed sheets had excellent outdoor weathering properties.

Although the preferred embodiments of the present invention have been disclosed and described in detail above, it should be understood that the invention is in no sense limited thereby and its scope is to be determined by that of the claims hereinafter.

The foregoing disclosure and description of the invention is illustrative and explanatory thereof and various changes in the illustrated process and product may be made within the scope of the appended claims without departing from the spirit of the inventions.

All patents and publications cited herein are hereby incorporated herein in their entirety.

What is claimed is:

1. A photovoltaic module comprising a pre-bonded backskin, said backskin comprising or produced from a multi-layer sheet, said sheet comprising;
a. a first polymer layer comprising a film selected from the group consisting of polyvinyl fluoride (PVF) and polyvinylidene fluoride (PVDF) and having an optional adhesive coating on one side;
b. a second polymer layer laminated in a face to face relationship to one side of the first polymer layer, said second polymer layer comprising a polymer selected from the group consisting of (1) an ionomer resin of a copolymer of ethylene and 8-25% by weight, based on the weight of the copolymer, of a C₃-C₈ α,β ethylenically unsaturated monocarboxylic acid at least 35% of acid moieties neutralized with metal ions and (2) a metallocene catalyzed very low density polyethylene (m-VLDPE) and said second layer optionally containing pigments, dyes, flakes and any mixtures thereof; and
c. optionally, a third polymer layer in direct contact with the second layer and bonded to the second layer over at least a portion of its surface.

2. The module of claim 1 in which the first polymer layer is treated on the side that bonds to the second polymer layer with a means for treating the first polymer layer by which the surface energy of the first polymer layer is raised to a level effective for producing adhesion between the first and second polymer layers.

3. The module of claim 1 in which the adhesive strength between the first polymer layer and the second polymer layer is less in the multi-layer sheet than it is in the module.

4. The module of claim 2 in which the means for treating is either by corona treatment or by flame treatment.

5. The module of claim 1 in which the third polymer layer comprises a polymer selected from the group consisting of (1) an ionomer resin of a copolymer of ethylene and 8-25% by weight, based on the weight of the copolymer, of a C₃-C₈ α,β ethylenically unsaturated monocarboxylic acid at least 35% of acid moieties neutralized with metal ions and (2) a copolymer of ethylene and an vinyl ester.

6. The module of claim 1 wherein the first polymer layer comprises a cast PVF film.

7. The module of claim 1 wherein the first polymer layer comprises a cast PVDF film.

8. The module of claim 1 wherein the first polymer layer comprises a PVF/polyester/PVF laminate film.

9. The module of claim 1 wherein the second polymer layer consists essentially of an ionomer resin of ethylene and 12-18% by weight, based on the weight of the copolymer, of methacrylic acid or 10-15% by weight, based on the weight of the copolymer of acrylic acid, and 35-75% neutralized with metallic ion selected from the group consisting of zinc, lithium, sodium, magnesium, calcium and any mixtures thereof and having a Melt Index of 0.4-4.0.

10. The module of claim 1 in which the optional adhesive coating comprises a thin acrylic adhesive layer positioned between the first and second polymer layers, said first or second polymer layers, or both, containing UV absorbers, UV stabilizers and mixtures thereof.

11. The module of claim 10 wherein the second polymer layer consists essentially of an ionomer of ethylene and 12-18% by weight, based on the weight of the polymer, of methacrylic acid or 10-15% by weight, based on the weight of the copolymer, of acrylic acid and is neutralized with zinc and optionally contains pigments, dyes, flakes and any mixtures thereof.

12. The module of claim 10 wherein the second polymer layer comprises a metallocene catalyzed very low density polyethylene and optionally contains pigments, dyes, flakes and any mixtures thereof.

13. The module of claim 10 wherein the first polymer layer comprises PVF, the second polymer layer consists essentially of an ionomer resin of ethylene and 12-18% by weight, based on the weight of the copolymer, of methacrylic acid or 10-15% by weight, based on the weight of the copolymer, of acrylic acid and 35-75% neutralized with metallic ion selected from the group consisting of zinc, lithium, sodium, magnesium, calcium and any mixtures thereof and optionally contains pigments, dyes, flakes and mixtures thereof.

14. The module of claim 10 wherein the first polymer layer comprises PVDF, the second polymer layer consists essentially of an ionomer resin of ethylene and 12-18% by weight, based on the weight of the copolymer, of methacrylic acid or 10-15% by weight, based on the weight of the copolymer, of acrylic acid and 35-75% neutralized with metallic ion selected from the group consisting of zinc, lithium, sodium, magnesium, calcium and any mixtures thereof and contains pigments, dyes, flakes and mixtures thereof.

15. The module of claim 1 wherein the first polymer layer comprises PVF, the second polymer layer comprises m-VLDPE and optionally contains pigments, dyes, flakes and mixtures thereof and an adhesive layer comprising an acrylic polymer containing UV absorbers, UV stabilizers and mixtures thereof is between the first and second polymer layers.

16. The module of claim 1 wherein the first polymer layer comprises PVDF, the second polymer layer comprises m-VLDPE and optionally contains pigments, dyes, flakes and mixtures thereof and an adhesive layer comprising an acrylic polymer and containing UV absorbers, UV stabilizers and mixtures thereof is between the first and second polymer layers.

17. The module of claim 1 comprising a third or subsequent layers applied by extrusion or film lamination to the second polymer layer.

18. The module of claim 1 comprising a third or subsequent layers applied by extrusion or film lamination to the second polymer layer and in which the third or subsequent layers encapsulate a plurality of solar cells.

19. The module of claim 1 in which the second polymer layer encapsulates a plurality of solar cells.

20. A multi-layer sheet comprising, or produced from, a first polymer layer comprising a film of polyvinyl fluoride or polyvinylidene fluoride having an adhesive coating on one side; a second polymer layer extruded onto the adhesive coating of the first polymer layer; and optionally, a third polymer layer.
